(19) United States
(12) Patent Application Publication
(10) Pub. No.: US 2024/0370886 A1
(43) Pub. Date: Nov. 7, 2024

(54) A SYSTEM AND PROCESS FOR ASSESSING AND REMEDYING BRAND BUYER RELATIONSHIPS IN DIGITAL CONTEXTS

(71) Applicant: RAMMP HOLDINGS PTY LTD, Brisbane, Queensland (AU)

(72) Inventor: Anna Harrison, Brisbane Queensland (AU)

(21) Appl. No.: 18/681,840

(22) PCT Filed: Aug. 1, 2022
(86) PCT No.: PCT/AU2022/050820

§ 371 Date: Feb. 6, 2024

(30) Foreign Application Priority Data
Aug. 6, 2021 (AU) 2021105053

(51) Int. Cl. G06Q 30/0201; G06Q 30/0251

(52) U.S. Cl. CPC G06Q 30/0201; G06Q 30/0251

(57) ABSTRACT

A system for configuring an interactive digital representation of an entity. Storing a plurality of interaction milestones in association with at least one interaction metric and a corresponding metric threshold. Each interaction metric is associated with a configuration corresponding to the interaction metric. Receiving a current interactive digital representation of an entity and interaction statistics for the current interactive digital representation and determining, for at least one interaction milestone, an interaction metric value for an interaction metric associated with said interaction milestone based the interaction statistics. Determining a candidate interaction metric of the interactive digital representation for reconfiguring. The candidate interaction metric is used to determine a configuration for the interactive digital representation using the configuration stored in the database for the candidate interaction metric. Configuring the interactive digital representation based on the determined configuration to update the current interactive digital representation of the entity.

### FIELD

The present invention generally relates to a system and a method of configuring an interactive digital representation of an entity. In particular, the present invention relates to configuring a website, a web application, a mobile application or a social media store to improve digital footprint efficacy.

### BACKGROUND

Ever since people could trade their goods, there was a question of increasing volume of sales. With expansion of the Internet and computer technologies, mechanisms for boosting sales have greatly improved.

Computer technologies which were originally developed for enabling technical functionality, such as cookies, have been adopted to track various characteristics of online users with the primary focus on increasing sales. Technologies which appear to be unrelated to sales, for example, web search engines, are nonetheless used for targeted advertising. Other technologies for improving sales also exist.

For example, systems for digital marketing monitor behaviour of potential customers to target advertising. Other systems focus on managing customer journey by gathering user experience data to map the customer journey as it happens (i.e. what actions were taken by a user on a website). The goal of customer journey management systems is either to understand the journey or use the user experience data to create more targeted advertising. Other techniques focus on collecting data to improve customer experience through personalisation or user experience design.

However, the problem of facilitating sales is often multi-faceted especially in the current world where goods and services can be purchased remotely and delivered from anywhere directly to the customer. Even with abundance of tools and technologies, businesses are still facing exactly the same question “How do I get people to buy from me?”.

As such, there is a need for a system and method which implements a systematic, repeatable and vetted process for increasing conversion rates, in particular in a complex setting of electronic commerce environment.

### SUMMARY

One aspect of the present invention provides a system for configuring an interactive digital representation of an entity to optimise a brand-buyer relationship based on interaction of at least one user with the interactive digital representation of the entity, the system comprising: a processor; a database coupled with the processor, the database being configured to store a plurality of interaction milestones in association with at least one interaction metric and a corresponding metric threshold, each interaction metric being associated with a configuration corresponding to the interaction metric; and memory coupled with the processor, memory being configured to store instructions which, when executed by the processor, cause the processor to: a) receive a current interactive digital representation of an entity and interaction statistics for the current interactive digital representation; b) for at least one interaction milestone, determine an interaction metric value for an interaction metric associated with said interaction milestone based on the interaction statistics to measure the brand-buyer relationship, wherein the at least one interaction milestone relates to a duration of interaction of the at least one user with the current interactive digital representation of the entity; c) determine at least one candidate interaction metric of the interactive digital representation for reconfiguring by comparing each of the determined interaction metric values with a corresponding metric threshold stored in the database; d) determine a configuration for the interactive digital representation using the configuration stored in the database for the at least one candidate interaction metric and the current interactive digital representation; and e) cause the entity server to configure the interactive digital representation based on the determined configuration to thereby update the current interactive digital representation of the entity and optimise the brand-buyer relationship.

The processor may be further configured to adjust the metric thresholds based on the entity. The plurality of interaction milestones preferably comprises a zero second interaction milestone, a ten seconds interaction milestone, a three minutes interaction milestone, a sign-up milestone, a first forty eight hours after sign-up milestone, and an upgrade milestone. The database may further store a weighting coefficient for each interaction milestone. The processor may further to: determine an entity score by combining interaction metric values for the plurality of interaction milestones weighted based on a weighting coefficient associated with a corresponding interaction milestone; and cause a display screen to display, on a user interface, the determined entity score to a user. Memory may store further instructions which, when executed by the processor, cause the processor to: in response to receiving, via the user interface, an indication from the user to improve the entity score, generate a configuration report using the determined entity score and the determined configuration and cause the display screen to display the generated report on the user interface.

The processor may further repeat steps a) to e) if the determined entity score is below an entity score threshold. The processor may further prioritise the determined configuration based on a priority of the configuration stored in the database.

Another aspect of the present invention provides a method of configuring an interactive digital representation of an entity to optimise a brand-buyer relationship based on interaction of at least one user with the interactive digital representation of the entity, the method comprising: a) receiving a current interactive digital representation of an entity and interaction statistics for the current interactive digital representation; b) for at least one interaction milestone, determining an interaction metric value for an interaction metric associated with said interaction milestone based on the interaction statistics to measure the brand-buyer relationship, wherein the at least one interaction milestone relates to a duration of interaction of the at least one user with the current interactive digital representation of the entity; c) determining at least one candidate interaction metric of the interactive digital representation for reconfiguring by comparing each of the determined interaction metric values with a corresponding metric threshold stored in a database, wherein the database stores a plurality of interaction milestones in association with at least one interaction metric and a corresponding metric threshold, each interaction metric being associated with a configuration corresponding to the interaction metric; d) determining a configuration for the interactive digital representation using the configuration stored in the database for the at least one candidate interaction metric and the current interactive digital representation; and e) causing the entity server to configure the interactive digital representation based on the determined configuration to thereby update the current interactive digital representation of the entity and optimise the brand-buyer relationship.

The method may further comprise adjusting the metric thresholds based on the entity. The plurality of interaction milestones preferably comprises a zero second interaction milestone, a ten seconds interaction milestone, a three minutes interaction milestone, a sign-up milestone, a first forty eight hours after sign-up milestone, and an upgrade milestone. The database may store a weighting coefficient for each interaction milestone.

The method may further comprise: determining an entity score by combining interaction metric values for the plurality of interaction milestones weighted based on a weighting coefficient associated with a corresponding interaction milestone; causing a display screen to display, on a user interface, the determined entity score to a user; and in response to receiving, via the user interface, an indication from the user to improve the entity score, generating a configuration report using the determined entity score and the determined configuration and causing the display screen to display the generated report on the user interface.

The method may comprise repeating steps a) to e) if the determined entity score is below an entity score threshold. The method may further comprise prioritising the determined configuration based on a priority of the configuration stored in the database.

Another aspect of the present disclosure provides an apparatus for configuring an interactive digital representation of an entity, the apparatus comprising a processor configured to perform the method of the above aspect.

A further aspect of the present disclosure provides a non-transitory computer-readable storage medium for configuring an interactive digital representation of an entity, the computer-readable storage medium storing instructions which, when executed by a processor, cause the processor to perform the method of the above aspect.

Other aspects are also disclosed.

### BRIEF DESCRIPTION OF DRAWINGS

A range of suitable embodiments should become apparent from the following description, which is given by way of example only, of at least one preferred but non-limiting embodiment, described with reference to the drawings, in which:

FIG. 1 shows example interaction or emotional milestones and interaction metrics associated with each milestone;

FIG. 2 is dataflow diagram of an AI system according to one implementation of the present disclosure;

FIGS. 3A and 3B collectively show structural implementation of a computer system upon which the disclosed arrangements can be implemented;

FIG. 4 shows a process of iteratively checking performance at each milestone in accordance with an implementation of the present disclosure;

FIG. 5 shows a user interface of a process of generating a digital brand romance score in accordance with an implementation of the present disclosure;

FIG. 6 demonstrates a use case of configuring an interactive digital representation of an entity in accordance with an implementation of the present disclosure;

FIG. 7 shows a method of configuring an interactive digital representation of an entity in accordance with one implementation of the present disclosure;

FIG. 8 is a flow-chart demonstrating a method of configuring an interactive digital representation in accordance with an alternative implementation of the present disclosure.

### DESCRIPTION OF EMBODIMENTS

Where reference is made in any one or more of the accompanying drawings to steps and/or features, which have the same reference numerals, those steps and/or features have for the purposes of this description the same function(s) or operation(s), unless the contrary intention appears.

The present disclosure uses escalation in commitment as effectively a formula for “product love” founded on the principles which influence decision making of potential customers, right at the DNA level. Embodiments described below demonstrate how to measure and evaluate the “escalation of commitment” to determine a score for an interactive digital representation of an entity. The determined score can be used to reconfigure the interactive digital representation and/or design a new product. The present disclosure approaches the problem of improving customer engagement in a novel and an unconventional way.

Some implementations of the present disclosure provide mechanisms for configuring and optimising online presence or an interactive digital representation of an entity to foster stronger brand buyer relationships, and thereby increase sales and repeat buys. The interactive digital representation for the purposes of the present disclosure refers to a website, a social media platform or an e-commerce store, a mobile application, a web application or the like.

Some embodiments of the present disclosure relate to digital marketing strategy, digital customer journey design, digital sales optimisation, digital customer loyalty, management and design of digital brand footprint, customer journey optimisation, and/or product team optimisation. Some embodiments of the present invention are intended to define a process through which any business or entity, in any sector, can systematically improve an interactive digital representation or digital footprint of that business or entity (e.g. website, web app, mobile app, etc). In some implementation, improvements of the interactive digital representation may result in an increased conversion rates (i.e. from stranger/site visitor to buyer and brand advocate) by way of designing for stronger buyer brand relationships through the improved interactive digital representation or digital footprint.

Additionally or alternatively, some embodiments of the present invention are intended to improve product team efficiency by providing a systematic approach for a process of designing, by a product team or similar, digital assets, or digital representations, such as websites, web applications, mobile applications, and/or social media stores. The provided systematic approach is founded on objective measures of the strength of relationship between the buyer and the brand.

To improve or configure online presence, some embodiments of the present disclosure rely on a quantifiable experience that a visitor has with an interactive digital representation of an entity regardless of what type of product or service the entity offers, or the target markets for the entity. The experience may comprise a plurality of interaction milestones. Each interaction milestone is associated with one or more measurable or quantifiable interaction metric (or simply “metric”).

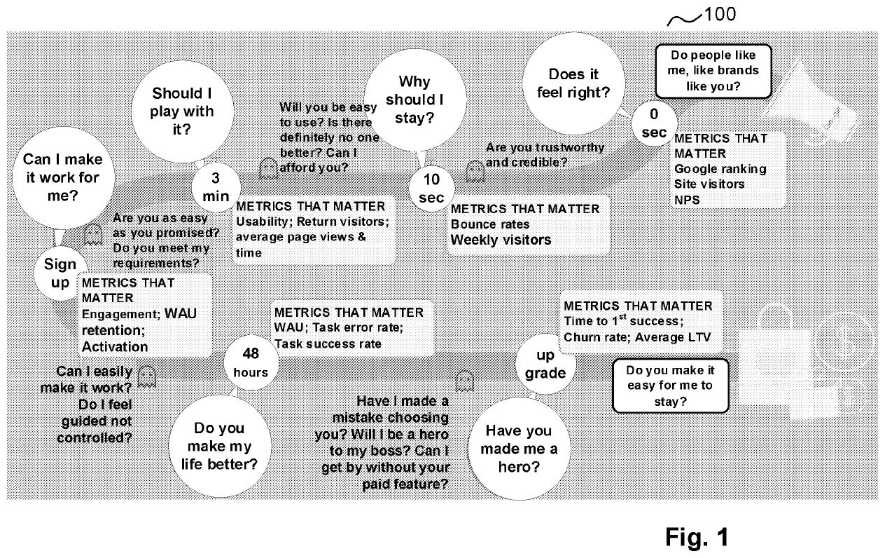

FIG. 1 shows an example 100 of interaction milestones (or “milestones” for brevity) and interaction metrics associated with each milestone. In some implementations, a plurality of interaction milestones may include milestone 1 (0 seconds, i.e. at the moment of arrival at the website), milestone 2 (10 seconds), milestone 3 (three minutes), milestone 4 (sign-up), milestone 5 (first 48 hours after sign-up) and milestone 6 (upgrade).

Examiner stages and metrics for each milestone are shown below:
Milestone 1 (0 seconds):
   Does it feel right?
   Metrics: Google™ ranking; number of site visitors; net promoter score (NPS).
Milestone 2 (ten seconds):
   Why should I stay?
   Metrics: Bounce rate; weekly visitors.
Milestone 3 (three minutes):
   Should I play with it?
   Metrics: Usability; return visitors; average page views and time.
Milestone 4 (sign-up):
   Can I make it work for me?
   Metrics: Engagement; weekly active users (WAU) retention; activation.
Milestone 5 (first 48 hours):
   Do you make my life better?
   Metrics: WAU, task error rate; task success rate.
Milestone 6 (upgrade):
   Have you made me a hero?
   Metrics: Time to first success; churn rate; average life time value (LTV).

In some implementations, the zero seconds milestone may be combined with the ten seconds milestone into a single 10 seconds milestone or a single zero to ten second stage. Optionally, the plurality of interaction milestones may also include milestone 7 (recommend or loyalty). The recommend milestone is considered to be the goal of the digital brand. The recommend or loyalty milestone effectively determines whether the digital brand is so strong that it attracts repeat buys and effectively facilitates milestones 1-6. Other combinations of milestones are also possible.

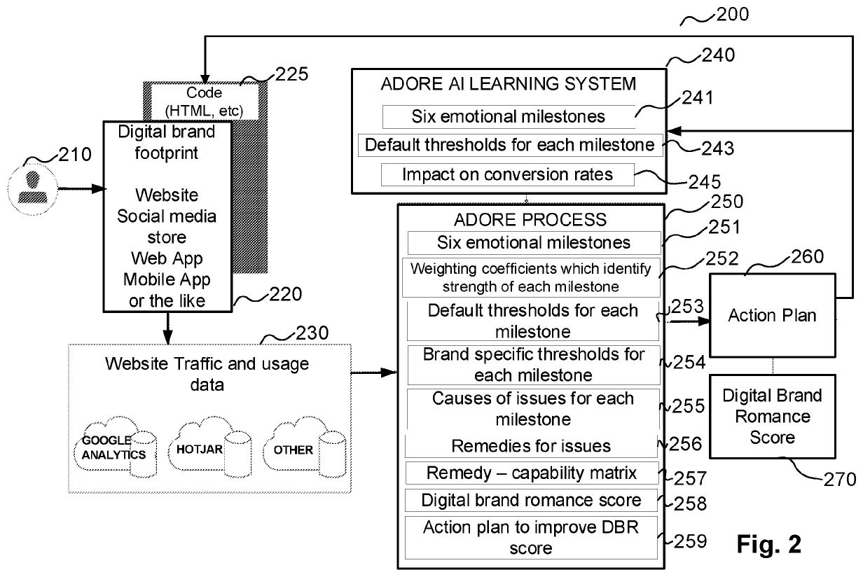

The present disclosure provides a specific computer implementation discussed with references to FIGS. 2 to 8 to measure a strength of the digital brand relationship, both overall and at each of the six milestones using the identified metrics. Additionally, the present disclosure provides a computer implemented method and system to turn the measurement at each step, into a configuration for the interactive digital representation which can be applied to the interactive digital representation to improve a customer satisfaction or “digital brand romance” (DBR) score. In some implementations, the computer method and system provide a design strategy in a form of a report which can be implemented by capable professionals.

Additionally, some embodiments of the present disclosure provide a way to identify what capabilities are needed to implement the recommended actions. For example, whether a copywriter is needed to improve your value proposition and/or whether a graphic designer and/or web developer are needed to improve first impression of the interactive digital representation. Additionally or alternatively, a one page graphic can be provided which can be used to optimise the performance of the product team.

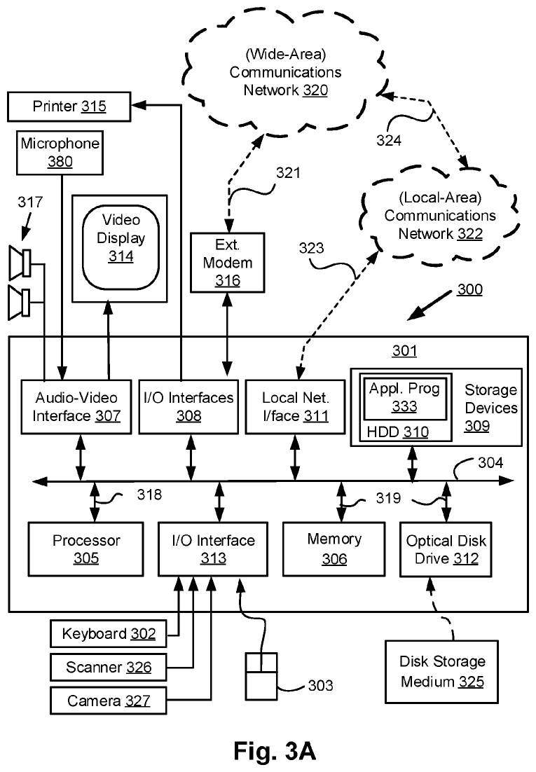

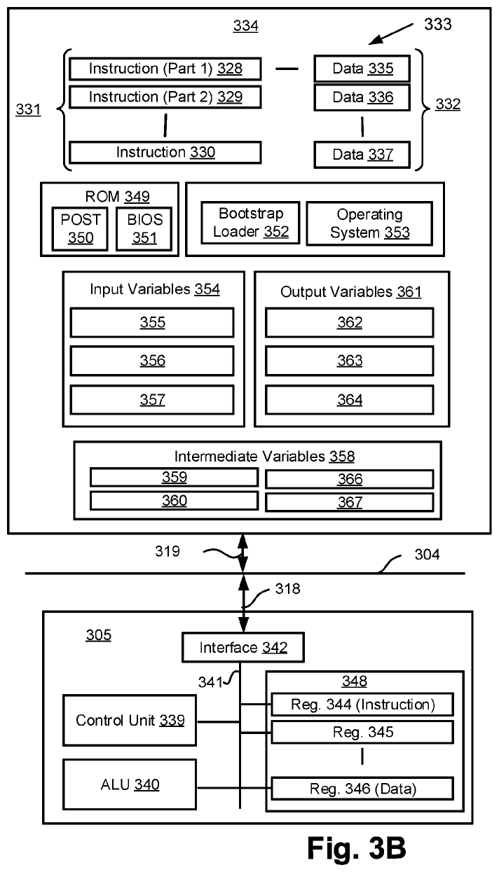

FIGS. 3A and 3B depict a general-purpose computer system 300, upon which the various arrangements described can be practiced.

As seen in FIG. 3A, the computer system 300 includes: a computer module 301; input devices such as a keyboard 302, a mouse pointer device 303, a scanner 326, a camera 327, and a microphone 380; and output devices including a printer 315, a display device 314 and loudspeakers 317. An external Modulator-Demodulator (Modem) transceiver device 316 may be used by the computer module 301 for communicating to and from a communications network 320 via a connection 321. The communications network 320 may be a wide-area network (WAN), such as the Internet, a cellular telecommunications network, or a private WAN. Where the connection 321 is a telephone line, the modem 316 may be a traditional “dial-up” modem. Alternatively, where the connection 321 is a high capacity (e.g., cable) connection, the modem 316 may be a broadband modem. A wireless modem may also be used for wireless connection to the communications network 320.

The computer module 301 typically includes at least one processor unit 305, and a memory unit 306. For example, the memory unit 306 may have semiconductor random access memory (RAM) and semiconductor read only memory (ROM). The computer module 301 also includes a number of input/output (I/O) interfaces including: an audio-video interface 307 that couples to the video display 314, loudspeakers 317 and microphone 380; an I/O interface 313 that couples to the keyboard 302, mouse 303, scanner 326, camera 327 and optionally a joystick or other human interface device (not illustrated); and an interface 308 for the external modem 316 and printer 315. In some implementations, the modem 316 may be incorporated within the computer module 301, for example within the interface 308. The computer module 301 also has a local network interface 311, which permits coupling of the computer system 300 via a connection 323 to a local-area communications network 322, known as a Local Area Network (LAN). As illustrated in FIG. 3A, the local communications network 322 may also couple to the wide network 320 via a connection 324, which would typically include a so-called “firewall” device or device of similar functionality. The local network interface 311 may comprise an Ethernet circuit card, a Bluetooth® wireless arrangement or an IEEE 802.11 wireless arrangement; however, numerous other types of interfaces may be practiced for the interface 311.

The I/O interfaces 308 and 313 may afford either or both of serial and parallel connectivity, the former typically being implemented according to the Universal Serial Bus (USB) standards and having corresponding USB connectors (not illustrated). Storage devices 309 are provided and typically include a hard disk drive (HDD) 310. Other storage devices such as a floppy disk drive and a magnetic tape drive (not illustrated) may also be used. An optical disk drive 312 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 300.

The components 305 to 313 of the computer module 301 typically communicate via an interconnected bus 304 and in a manner that results in a conventional mode of operation of the computer system 300 known to those in the relevant art. For example, the processor 305 is coupled to the system bus 304 using a connection 318. Likewise, the memory 306 and optical disk drive 312 are coupled to the system bus 304 by connections 319. Examples of computers on which the described arrangements can be practised include IBM-PC's and compatibles, Sun Sparcstations, Apple Mac™ or like computer systems.

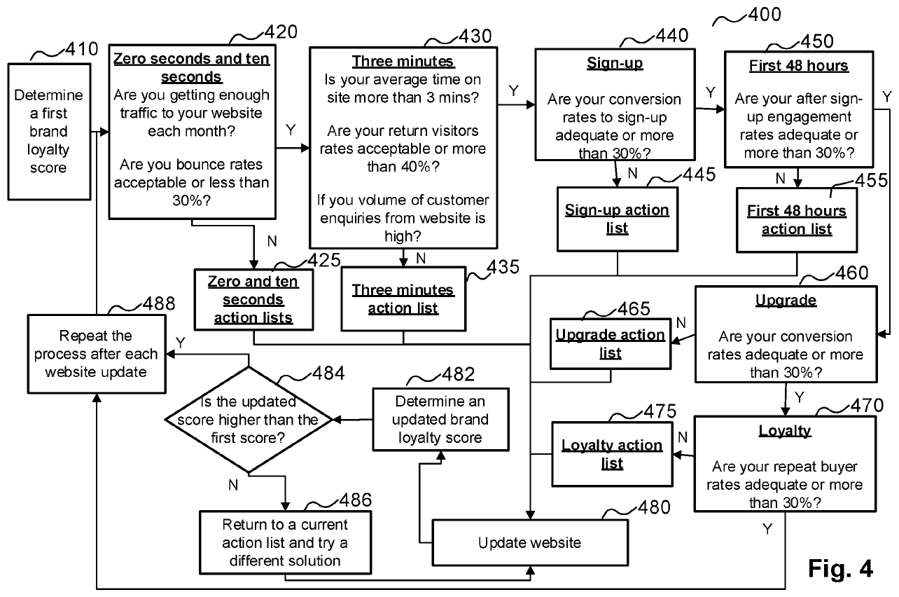

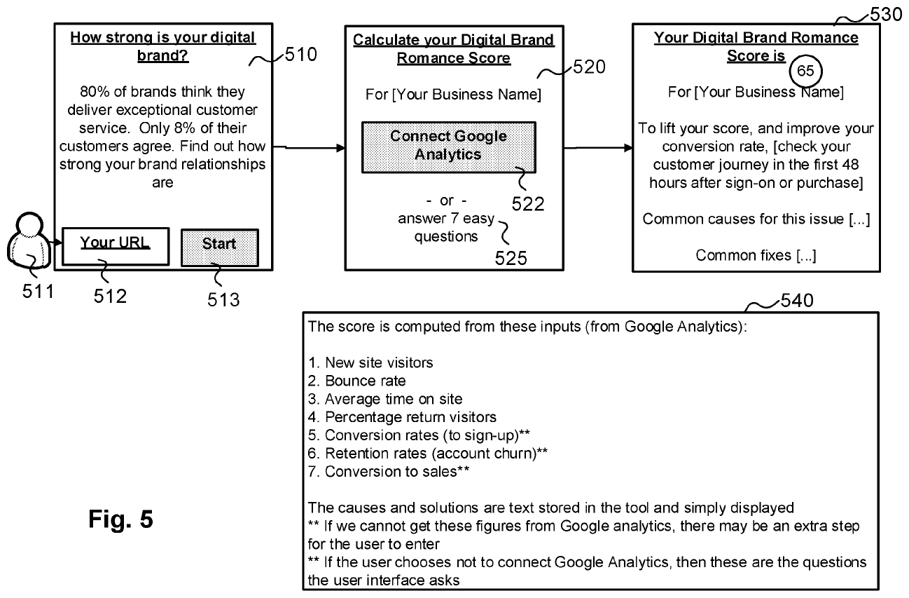

The method of FIGS. 4, 7 and 8 may be implemented using the computer system 300 wherein the processes of FIGS. 4, 7 and 8, to be described, may be implemented as one or more software application programs 333 executable within the computer system 300. In particular, the steps of the method of FIGS. 4, 7 and 8 are effected by instructions 331 (see FIG. 3B) in the software 333 that are carried out within the computer system 300. The software instructions 331 may be formed as one or more code modules, each for performing one or more particular tasks. The software may also be divided into two separate parts, in which a first part and the corresponding code modules performs the FIGS. 4, 7 and 8 methods and a second part and the corresponding code modules manage a user interface, for example, shown in FIG. 5, between the first part and the user.

The software may be stored in a computer readable medium, including the storage devices described below, for example. The software is loaded into the computer system 300 from the computer readable medium, and then executed by the computer system 300. A computer readable medium having such software or computer program recorded on the computer readable medium is a computer program product. The use of the computer program product in the computer system 300 preferably effects an advantageous apparatus for configuring an interactive digital representation of an entity.

The software 333 is typically stored in the HDD 310 or the memory 306. The software is loaded into the computer system 300 from a computer readable medium, and executed by the computer system 300. Thus, for example, the software 333 may be stored on an optically readable disk storage medium (e.g., CD-ROM) 325 that is read by the optical disk drive 312. A computer readable medium having such software or computer program recorded on it is a computer program product. The use of the computer program product in the computer system 300 preferably effects an apparatus for configuring an interactive digital representation of an entity.

In some instances, the application programs 333 may be supplied to the user encoded on one or more CD-ROMs 325 and read via the corresponding drive 312, or alternatively may be read by the user from the networks 320 or 322. Still further, the software can also be loaded into the computer system 300 from other computer readable media. Computer readable storage media refers to any non-transitory tangible storage medium that provides recorded instructions and/or data to the computer system 300 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 301. Examples of transitory or non-tangible computer readable transmission media that may also participate in the provision of software, application programs, instructions and/or data to the computer module 301 include radio or infra-red transmission channels as well as a network connection to another computer or networked device, and the Internet or Intranets including e-mail transmissions and information recorded on Websites and the like.

In some implementations, the computer system 300 may be a web server or a distributed (cloud-based) web server. For example, the web server may receive a command from a web browser via the network 320 to execute the application program 333 stored in HDD 310 or the memory 306. In response to receiving the command from the web browser, the web server may execute instructions 331 of the application program 333.

The second part of the application programs 333 and the corresponding code modules mentioned above may be executed to implement one or more graphical user interfaces (GUIs) to be rendered or otherwise represented upon the display 314. Through manipulation of typically the keyboard 302 and the mouse 303, a user of the computer system 300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 317 and user voice commands input via the microphone 380.

FIG. 3B is a detailed schematic block diagram of the processor 305 and a “memory” 334. The memory 334 represents a logical aggregation of all the memory modules (including the HDD 309 and semiconductor memory 306) that can be accessed by the computer module 301 in FIG. 3A.

When the computer module 301 is initially powered up, a power-on self-test (POST) program 350 executes. The POST program 350 is typically stored in a ROM 349 of the semiconductor memory 306 of FIG. 3A. A hardware device such as the ROM 349 storing software is sometimes referred to as firmware. The POST program 350 examines hardware within the computer module 301 to ensure proper functioning and typically checks the processor 305, the memory 334 (309, 306), and a basic input-output systems software (BIOS) module 351, also typically stored in the ROM 349, for correct operation. Once the POST program 350 has run successfully, the BIOS 351 activates the hard disk drive 310 of FIG. 3A. Activation of the hard disk drive 310 causes a bootstrap loader program 352 that is resident on the hard disk drive 310 to execute via the processor 305. This loads an operating system 353 into the RAM memory 306, upon which the operating system 353 commences operation. The operating system 353 is a system level application, executable by the processor 305, to fulfil various high level functions, including processor management, memory management, device management, storage management, software application interface, and generic user interface.

The operating system 353 manages the memory 334 (309, 306) to ensure that each process or application running on the computer module 301 has sufficient memory in which to execute without colliding with memory allocated to another process. Furthermore, the different types of memory available in the system 300 of FIG. 3A must be used properly so that each process can run effectively. Accordingly, the aggregated memory 334 is not intended to illustrate how particular segments of memory are allocated (unless otherwise stated), but rather to provide a general view of the memory accessible by the computer system 300 and how such is used.

As shown in FIG. 3B, the processor 305 includes a number of functional modules including a control unit 339, an arithmetic logic unit (ALU) 340, and a local or internal memory 348, sometimes called a cache memory. The cache memory 348 typically includes a number of storage registers 344-346 in a register section. One or more internal busses 341 functionally interconnect these functional modules. The processor 305 typically also has one or more interfaces 342 for communicating with external devices via the system bus 304, using a connection 318. The memory 334 is coupled to the bus 304 using a connection 319.

The application program 333 includes a sequence of instructions 331 that may include conditional branch and loop instructions. The program 333 may also include data 332 which is used in execution of the program 333. The instructions 331 and the data 332 are stored in memory locations 328, 329, 330 and 335, 336, 337, respectively. Depending upon the relative size of the instructions 331 and the memory locations 328-330, a particular instruction may be stored in a single memory location as depicted by the instruction shown in the memory location 330. Alternately, an instruction may be segmented into a number of parts each of which is stored in a separate memory location, as depicted by the instruction segments shown in the memory locations 328 and 329.

In general, the processor 305 is given a set of instructions which are executed therein. The processor 305 waits for a subsequent input, to which the processor 305 reacts to by executing another set of instructions. Each input may be provided from one or more of a number of sources, including data generated by one or more of the input devices 302, 303, data received from an external source across one of the networks 320, 302, data retrieved from one of the storage devices 306, 309 or data retrieved from a storage medium 325 inserted into the corresponding reader 312, all depicted in FIG. 3A. The execution of a set of the instructions may in some cases result in output of data. Execution may also involve storing data or variables to the memory 334.

The disclosed arrangements for configuring an interactive digital representation of an entity use input variables 354, which are stored in the memory 334 in corresponding memory locations 355, 356, 357. The arrangements for configuring an interactive digital representation of an entity produce output variables 361, which are stored in the memory 334 in corresponding memory locations 362, 363, 364. Intermediate variables 358 may be stored in memory locations 359, 360, 366 and 367.

Referring to the processor 305 of FIG. 3B, the registers 344, 345, 346, the arithmetic logic unit (ALU) 340, and the control unit 339 work together to perform sequences of micro-operations needed to perform “fetch, decode, and execute” cycles for every instruction in the instruction set making up the program 333. Each fetch, decode, and execute cycle comprises:
a fetch operation, which fetches or reads an instruction 331 from a memory location 328, 329, 330;
a decode operation in which the control unit 339 determines which instruction has been fetched; and
an execute operation in which the control unit 339 and/or the ALU 340 execute the instruction.

Thereafter, a further fetch, decode, and execute cycle for the next instruction may be executed. Similarly, a store cycle may be performed by which the control unit 339 stores or writes a value to a memory location 332.

Each step or sub-process in the processes of FIGS. 4, 7 and 8 is associated with one or more segments of the program 333 and is performed by the register section 344, 345, 347, the ALU 340, and the control unit 339 in the processor 305 working together to perform the fetch, decode, and execute cycles for every instruction in the instruction set for the noted segments of the program 333.

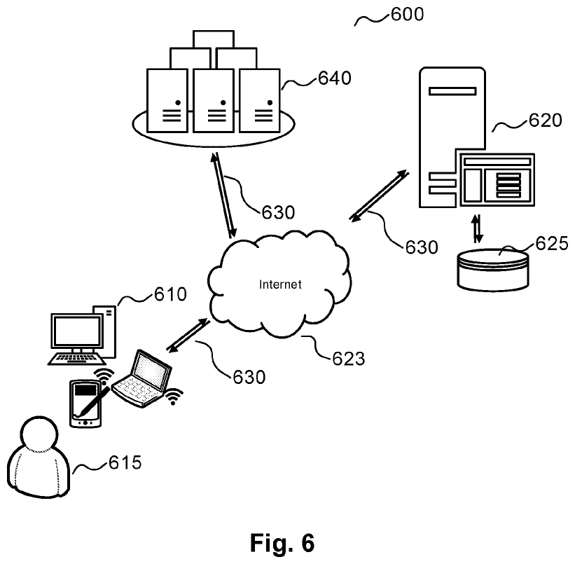

FIG. 6 shows a web-services infrastructure 600 for configuring an interactive digital representation of an entity in accordance with one implementation of the present disclosure. In accordance with one implementation, the infrastructure 600 comprises a user device 610 having a user interface for receiving commands from a user 615, a server 620 controlling and coupled with a database 625 and an entity server 640 hosting an interactive digital representation of an entity. The user device 610, for example, can be a laptop, a personal computer, a mobile device or the like. The user device 610, the server 620 and the entity server 640 may have similar configurations as the computer system 300.

The user device 610, the server 620 and the entity server 640 may be connected with each other via a communications network, for example the Internet 623, using wired or wireless connections 630 in accordance with known communication protocols. The server 620 may be a web server or a distributed (cloud-based) web server. For example, the server 620 may be configured to receive a command from a web browser of the user device 610 via the Internet 623 to execute the application program 333 stored in HDD 310, the memory 306 or otherwise provided to the server 620. In response to receiving the command from the web browser, the server 620 may execute instructions 331 of the application program 333.

The user 615 may enter a command using the user interface to determine a DBR score for an entity by specifying a URL in the command. The command is sent to the server 620 via the Internet 623. The server 620 processes the command using statistical data regarding usage of an interactive digital representation provided in the URL and determines the DBR score and a plurality of instructions to reconfigure the interactive digital representation. The determined score and the recommended changes in configuration may be displayed on a display screen of the user device 610. The user may select some or all of the recommended configurations to be applied to the interactive digital representation. In response to the user selection, the server 620 may transmit the selected configurations to the entity server 640 as a set of instructions to reconfigure the interactive digital representation. In alternative implementations, the server 620 may apply some or all of the plurality instructions to reconfigure the interactive digital representation automatically without checking with the user.

A system for configuring an interactive digital representation comprises a processor, a database coupled with the processor and memory coupled with the processor and storing instructions for execution by the processor. The system may have similar structural configuration as the computer system 300. The processor may be the processor 305 of the server 620, the database may be the database 625 and memory may be, for example memory 334 of the server 620.

The database is configured to store a plurality of interaction milestones in association with at least one interaction metric and a corresponding metric threshold. Additionally, the database may store a weighting coefficient for each interaction milestone representing impact of each of the milestones.

The plurality of interaction milestones preferably comprises milestones 0 to 5 discussed above, i.e. the emotional journey may include a zero seconds milestone, a 10 seconds milestone, a sign-up milestone, a first 48 hours after sign up milestone, an upgrade milestone. Other milestones are also possible. Additionally, milestones, 10 seconds, 3 minutes etc. may be different for different contexts, e.g. educational programs, children content, enterprise software, etc.

Each interaction milestone is associated with one or more interaction metric. For example, the zero seconds milestone may be associated with a Google™ ranking metric, a number of site visitors metric, a net promoter score (NPS) metric. The 10 seconds milestone may be associated with a bounce rate metric and a weekly visitors metric. The 3 minutes milestone may be associated with a usability metric, a number of return visitors metric and an average page views and time metric. The sign up milestone may be associated with an engagement metric, a weekly active users (WAU) retention metric, an activation metric. The first 48 hours after sign-up milestone may be associated with a WAU metric, a task error rate metric and a task success rate metric. The upgrade milestone may be associated with a time to first success metric, a churn rate metric, an average life time value (LTV) metric.

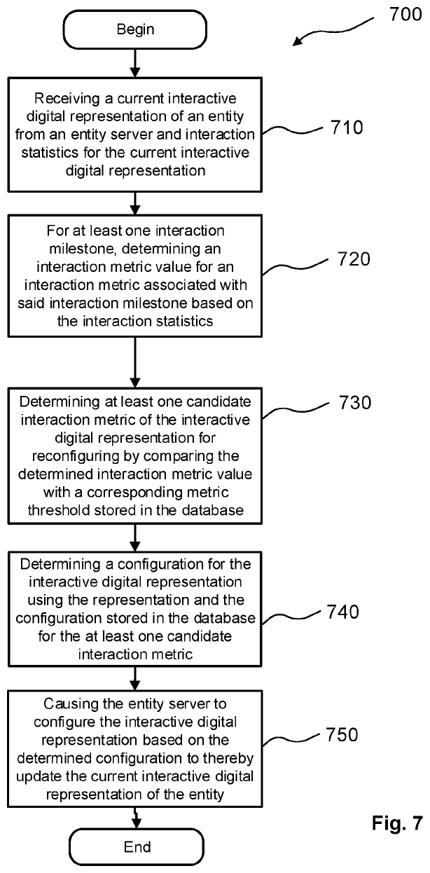

For each metric, the database may store a corresponding threshold. For example, 40% for the number of return visitors metric. The metric thresholds may be adjusted by the user and/or based on the entity. Each interaction metric may be associated, in the database, with a configuration. For example, a specific configuration may be stored for each interaction metric in the database. Alternatively, one or more configurations may be stored for each milestone, i.e. a configuration is associated with a metric via milestone. Example thresholds and configurations are discussed below with references to FIG. 7.

The processor, when executing instructions stored in memory, is configured to receive a current interactive digital representation of an entity, for example a URL or an HTML code, and interaction statistics for the current interactive digital representation. The URL may be received from a user device, e.g. 610, the HTML code may be received from an entity server, e.g. 640. The entity server may have similar configuration as a computer system 300 discussed above.

In response to receiving the digital representation, for example in a form of a URL, and the interaction statistics, the processor is configured to determine an interaction metric value for an interaction metric associated with at least one interaction milestone based on the current interactive digital representation and the interaction statistics. For example, the processor may determine an interaction metric value for the number of site visitors metric.

The processor is further configured to determine a candidate interaction metric of the interactive digital representation for reconfiguring by comparing each of the determined interaction metric values with a corresponding metric threshold stored in the database. For example, a bounce rate metric may be selected as a candidate interaction metric if a bounce rate metric value is higher than the threshold for the bounce rate metric, e.g. 30%.

In response to determining the candidate interaction metric, the processor is configured to determine a configuration for the interactive digital representation using the configuration stored in the database for the candidate interaction metric. For example, for the bounce rate metric, the processor may choose “Aesthetics”, “Readability” and “Readability on a mobile device” configurations.

The processor is configured to cause, i.e. send instructions to, the entity server to configure the interactive digital representation based on the determined configuration to thereby update the current interactive digital representation of the entity. For example, the processor may generate instructions for rearranging content in accordance with best industry practices, reconfiguring fonts, images arrangement and the like as well as adapting arrangements to better suit for mobile devices. The instructions for rearranging content may be sent by the server 620 to the entity server 640.

In some implementations, additionally or alternatively to determining a configuration, the processor may determine an entity score based on the determined interaction metric value. For example, the entity score or the DBP score may be determined by combining interaction metric values for the plurality of interaction milestones, with each metric value being weighted based on a weighting coefficients associated with a corresponding interaction milestone.

The system may additionally provide a user interface enabling the user to determine whether the interactive digital representation should be reconfigured. For example, the processor may also cause the display screen of the user device to display, using the user interface, the determined entity score to a user. The user device may have similar configuration as the computer system 300 discussed above.

The user may select a user interface element, for example, a button, to indicate that the user would like to improve the score. Other ways of providing a user input are also possible, for example, using a sliding gesture, voice command and the like. In response to receive an indication from the user to improve the score, the processor may generate a configuration report using the determined entity score and the determined configuration. The user may review the report and indicate, via the user interface, which configurations are to be effected. The processor may be further configured to cause the entity server to configure the interactive digital representation based on the selected configuration(s) to thereby update the current interactive digital representation of the entity. The processor may repeat the above steps if a DBR score for the updated current digital representation is below an entity score threshold. The entity score threshold may be stored in memory 334 as a default value. Alternatively, the entity score threshold may correspond to the entity score determined by the processor in a previous iteration.

In accordance with some implementations, the user may review the report by going through a checklist on each page and identify areas where the entity may have gaps. The selected items in the checklist may be collated, by the processor, into a digital strategy action plan.

For example, company X wants to create a marketing strategy to drive more traffic to their website. The company X can run through the checklist in the report, and discover that 94% of all people who sign-up for their product churn within the first week. The company X uses the report to formulate an ordered set of actions to implement. For example, the company X may apply recommended configurations for the website, mobile application, web application and/or social media account and/or engage professionals recommended in the report.

An example high level summary provided in the report is shown below in Table 1.

TABLE 1
Example high level summary in the report

| No. | Items to check | Actions |
|---|---|---|
| 1. | Optimise your website for SEO rankings on Google ™ | SEO Optimisation Actions |
| | Search | * Conceptually first in the |
| 2. | Review your value proposition: is it clear how you | customer journey, but last in |
| | make your audience's life better? | their execution in the action |
| 3. | Review your site aesthetic: are you sending the right | plan |
| | vibe through your use of colour, imagery and | |
| | typography? | |
| 4. | Review your Google ™ Ad words: are site visitors | |
| | getting what they expected when they land on your | |
| | site? | |
| 5. | Have you adequately described your value to your | Value Proposition Actions |
| | audience? | Web Page Optimisation |
| 6. | Is it clear how you will make your site visitor's life | Actions SEO Optimisation |
| | better? | Actions |
| 7. | Have you explained your offering in a customer centric | |
| | way? If your website talks about your product features | |
| | and internal processes, it is a telltale sign that your | |
| | messaging is inward focused. | |
| 8. | Are your after sign-on churn (or abandon) rates high | Onboarding Actions |
| | (70%+)? | |
| 9. | Is it possible to succeed in the first 48 hrs after | Usability Testing Actions |
| | signing on, regardless of how complicated your full- | |
| | featured product is? | |
| 10. | Is it clear what to do after sign-on? | |

The disclosed process for generating the digital brand romance (DBR) score and associated set of actions are intended to improve brand buyer relationships.

FIG. 5 shows examples of a user interface displayed on a display screen of the user device 610 showing different stages the process of generating the digital brand romance score.

The user interface may include a page 510 providing a user 511 a field 512 to identify an interactive digital representation. For example, the user may enter a URL of a website, a name of a mobile application or the like in the field 512. The user 511 may press a button 513 to indicate, for example to the server 620, that the user would like to determine the DBR score for the identified entity.

In response to receiving the request from the user 511, the server 620 may cause a user device 610 to display on the display screen a page 520. Page 520 may be customized for the entity, for example, based on the URL indicated in the field 512, by displaying the entity name. The page 520 may include a selectable user interface element 522 to connect Google Analytics™ and a selectable user interface element 525 to answer questions.

Upon either selecting to connect Google Analytics™ or answering questions, the user interface displays a page 530 showing a digital brand romance score determined based on the answers and/or statistical data obtained from Google Analytics™ and, optionally, the interactive digital representation. Page 530 may be customized in a similar manner as page 520. Additionally, page 530 may indicate, based on the DBR score, a one or more milestones which need improvement, for example, the first 48 hours milestone. Page 530 may also include common causes of the identified issues and common fixes. The causes and solutions may be provided by the server 620 and stored as text in memory 334 of the user device 610. Alternatively, the causes and solutions may be stored as text in memory of the server 620 and rendered on a display screen of the user device 610.

A page 540 may be displayed separately or alongside page 530. Page 540 provides overview of inputs used to determine the score. For example, page 540 may indicate that the score was computed from inputs provided by Google Analytics™, such as new site visitors, bounce rate, average time on site, percentage of return visitors, conversion rates (to sign-up), retention rates (account churn), conversion to sales. If some inputs cannot be obtained from Google Analytics™, the user interface may have additional pages to answer questions related to required inputs, such as retention rate, conversion to sales etc.

FIG. 7 shows a method 700 of configuring an interactive digital representation of an entity. Method 700 is implemented on a processor 305 under control of instructions stored in memory 309.

Method 700 commences with a step 710 of receiving a current interactive digital representation of an entity from an entity server, for example the server 640, and interaction statistics for the current interactive digital representation. The current interactive digital representation may be received as a URL. In some implementations, step 710 may fetch the interaction statistics using the URL from web traffic and usage data services, such as Google Analytics™, Hotjar™ etc.

Execution of method 700 continues from step 710 to a step 720 of determining, for at least one interaction milestone, an interaction metric value for an interaction metric associated with the interaction milestone based on the interaction statistics. Step 720 proceeds to a step 730 of determining at least one candidate interaction metric of the interactive digital representation by comparing the determined interaction metric value with a corresponding metric threshold stored in the database. The metric may be selected as a candidate metric if the metric value does not satisfy the threshold.

For example, a threshold for a Google™ ranking metric may relate to the website appearing not on page one of Google™ search results since 94% of all traffic on the Internet is from Page One of Google™ search results.

A threshold for a number of site visitors metric may relate to a relative change in the number of site visitors since the absolute numbers are hard to predict and may varies depending on industry. For example, 100 monthly site visitors could be an excellent outcome for an engineering company whereas 1 million monthly site visitors would be an excellent outcome for a mid-sized ecommerce brand. The threshold for the number of site visitors metric may be tied to a relative number, increase or decrease in the number of visitors in per cent. For example, looking at Google Analytics™, decrease in monthly site visitors by over 20% may be an indication that some improvements may be needed.

A threshold for a weekly user retention rates metric may be set at 30%, i.e. the criteria may be met if more than 30% of people who create an account come back and use the application and/or website again within a week of creating the account. A threshold for an activation rates metric may be set at 50%, i.e. the criteria may be met if more than 50% of site visitors complete the sign-up process. A threshold for a task error metric can be set to be 10%, i.e. the task error rate is expected to be less than 10% for a healthy website. A threshold for a time to first success metric may be within the first session after sign-up, for example, the first task is expected to be completed successfully within the first 5 minutes.

A threshold for an average lifetime value (LTV) metric may be set based on a particular industry to which the brand pertains or may be brand specific. For example, the average LTV may be set as the customer acquisition cost (CAC) which may be industry specific. In some implementations, the average LTV threshold may be set based on the average buy/basket size to indicate repeat buys. Alternatively, the average LTV threshold may be tied to the number of repeat buys, e.g. the average LTV threshold may be set as 2 buys, i.e. if buyer buy on average 2 times or more, the criterion is considered to be satisfied. The thresholds may be default thresholds or preconfigured for a particular entity.

Method 700 proceeds from step 730 to a step 740 of determining a configuration for the interactive digital representation using the interactive digital representation and the configuration stored in the database for the at least one candidate interaction metric. A configuration may be, for example, “keywords”, “ad words”, “landing pages”, “tracking feedback”, “aesthetics”, “readability”, “readability on a mobile device”, “online shopping”, “difficult sign-up”, “trial”, “usability”, “success”, “reminders”, “sharing”, “repeat buys”.

An example mapping between metrics, thresholds and configurations is shown below in Table 2.

TABLE 2
Example mapping between metrics, thresholds and configurations

| | Threshold and | |
|---|---|---|
| Metric | associated criteria | Suggested configuration |
| Google ™ ranking | <10 or on page 1 of | Ad words |
| | Google ™ search | Keywords |
| | results | |
| Decrease in the | <20% | SEO |
| number of site | | Website traffic |
| visitors | | Website visitors |
| | | Digital marketing |
| NPS | >9 or an NPS | Landing pages |
| | indicating promoters | Tracking feedback |
| Bounce rate | <30% | Aesthetics |
| | | Readability |
| | | Readability on a mobile device |
| | | Relatability (can a visitor |
| | | easily tell how the |
| | | advertised product will |
| | | make their life better) |
| | | Copywriting |
| Decrease in the | <20% | Aesthetics |
| number of weekly | | Readability |
| visitors | | Readability on a mobile device |
| Number of return | >40% | Online shopping |
| visitors | | Trial |
| Average page views | >3 minutes | Difficult sign-up |
| and time | | Trial |
| Engagement | >30% | Online shopping |
| | | Difficult sign-up Pricing model |
| Weekly active users | >30% of site visitors | Usability |
| retention rates | | Relevance |
| | | Difficult sign-up |
| Activation rates | >50% of site visitors | Usability |
| | | Difficult sign-up |
| Decrease in the | <20% | Usability |
| number of weekly | | Onboarding |
| active users | | Relevance |
| Task error rate | <10% | Usability |
| | | User experience (UX) |
| Task success rate | >90% | Usability |
| | | UX |
| Time to first | <5 mins after sign up | Usability |
| success | or within first session | |
| | after sign-up | |
| Churn rate | >70% | Success |
| | | Churn |
| | | Lost opportunity |
| Average life | >average purchase | Reminders |
| time value | for the entity | Sharing |
| | | Repeat buys |
| | | Recommendations |

The keyword configuration refers to reconfiguring keywords based on keywords typically used in that field which correspond to the interactive digital representation. The ad word configuration may refer to selecting more popular ad words suitable for the entity. The landing page configuration may refer to developing different landing pages for different campaigns of the interactive digital representation for tracking feedback. The tracking feedback configuration may refer to configuring the digital representation to connect an analytical tool to track and measure customer journeys. The aesthetics configuration refers, for example, to rearranging content in accordance with best industry practices. “Readability” may refer to reconfiguring fonts, images arrangement and the like. Readability on a mobile device is similar to readability configuration, however, tested for a mobile device. Readability on a mobile device may be particularly important since mobile devices now generate majority of Internet traffic. The online shopping configuration may refer to implementing functionality on the website for selling advertised products online. The difficult sign-in configuration may be targeting simplifying sign in of a web site, a mobile or web application or a social media store by reducing the number of user inputs and/or for example enabling linking of user accounts from other systems, such as Facebook™, Google™ etc. The trial configuration may, for example, implement mechanisms for trialing the product advertised by the entity. The usability configuration may include automatic usability testing and redesigning pages which result in user errors. The reminders configuration may include functionality for reminding visitors of their experience and prompting the visitors to continue their journey to commit to buy or further play with the product. The sharing configuration includes functionality to enable the visitors to share their experience with the interactive digital representation and/or the product. The repeat buys configuration may include functionality for customizing a user interface for repeat buyers.

Method 700 continues from step 740 to a step 750 of causing the entity server, e.g. 640, to configure the interactive digital representation based on the determined configuration to thereby update the current interactive digital representation of the entity. Step 750 may involve sending instructions from the server 630 to the entity server 640 corresponding to the determined configuration. Method 700 concludes on completion of step 740.

FIG. 4 shows an iterative process 400 in accordance with one implementation of method 700. The iterative process is described in the content of an interactive digital representation being a website, but can be implemented with other kinds of digital representations.

One implementation may commence with determining 410 a first brand loyalty score. The first brand loyalty score may be initially set as 0. The implementation shown in FIG. 4 effectively goes through the milestones in chronological order of the milestones to check whether criteria for milestone are satisfied and iteratively updates the interactive digital representation in case any criterion is violated.

In step 420, process 400 checks the zero and 10 seconds milestones, i.e. determines “does it feel right?” and “why should I stay?”. In particular, step 420 determines whether there is enough traffic to the website each month and whether the bounce rates is acceptable (for example below 30%). If there is enough traffic to the website each month and the bounce rate is acceptable, step 420 proceeds to step 430 of checking the 3 minutes milestone. Alternatively, if there is not enough traffic to the website each month and/or the bounce rate is not acceptable, step 420 proceeds to a step 425 of implementing a 0 and 10 seconds action list. The 0 and 10 seconds action list effectively provides a list of suggested configurations for updating the website. Step 425 continues to a step 480 of updating the website. The action list may include a broad statement to review marketing strategy to get more traffic to the website and a detailed action list shown below:
1. Optimise the website for search engine optimization (SEO) rankings on Google™ Search:
   Reconfigure structure of the website. For example, using a SEO analyzing tool, for example, a Neil Patel's Site Analyser.
   Reconfigure keywords in an HTML code of the website and in adwords, e.g. Google™ Ads, Facebook™ Ads, etc. Searching keywords for the entity using keyword tools, such as Keywords Everywhere to find the right keywords.
2. Scaling marketing efforts:
   Suggesting an association, or a partnership with a third party to get more potential customers;
   Suggesting reconsidering marketing activations to ensure that the marketing activations focus on creating value for potential customers since the only reason anyone buys anything is because it makes their life better.
3. Measure, test, refine
   Connect the website to an analytical service, such as GoogleAnalytics™.
   Automatically track bounce rates and monthly visitors;
   Automatically track where the visitors are coming from;
   Generate landing pages for different campaigns to track effectiveness;
   Configure the website using GoogleAd™ to experiment with keyword combinations.

The action list may also include suggested specific configurations for reducing bounce rates. For example:
Review the value proposition associated with the website: is it clear how the entity makes visitors' life better?
Reconfigure the website aesthetic, i.e. images, fonts, colours etc. to ensure that the website sends the right vibe through your use of colour, imagery and typography.
Reconfigure the ad words, e.g. GoogleAd™ to ensure that the website visitors get what they expected when they land on the website.

The 0 and 10 seconds action list may also specify resources to get additional help. For example, for the first milestone that can be engaging a digital agency with access to SEO optimization, copywriting, graphic design and web design.

Returning to process 400, step 430 checks the 3 minutes stage “Should I play with it?”. In step 430, the process 400 checks whether website visitors spend 3 minutes or more on the website, whether return visitor rates are acceptable, e.g. more than 40%, and whether visitors can find what they need on your website. For example, if the website does not measure UX success rates directly, step 430 may determine whether visitors can find what they need by checking the volume of enquiries from first time visitors.

If all questions are determined to be affirmative, step 430 proceeds to a step 440 of checking the sign-up milestone. Alternatively, step 430 proceeds to step 435 of generating a 3 minutes action list. Step 435 may generate the 3 minutes action list with a broad summary of optimising layouts/content flow of the website to get better engagement in the first 3 minutes. Additionally, the 3 minutes action list may outline suggested configurations:
Follow best practice with respect to placement of information on the website;
Reconfigure the structure of the website to make it intuitive;
Reconfigure the keywords on pages of the website;
Improve readability of the website, e.g. subdividing paragraphs as long paragraphs of text may be hard;
Improve readability of the website on a mobile device. Suggesting a purpose-built mobile application since 84% of all website traffic comes from mobile devices;
Consider whether the website adequately describes value of the entity to the visitors;
Consider whether the website makes it clear how the entity will make visitor's life better;
Reconfigure offering to describe the offering in a customer centric way rather than talking about product features and internal processes.

The 3 minutes action list for the second milestone may also recommend engaging a digital agency with access to skills on brand development, copywriting, graphic design and web design. Similar to step 425, after completion, step 435 proceeds to step 480.

Step 440 checks the signup milestone, i.e. “Can I make it work for me?” milestone. In some implementations, step 440 determines whether conversion to signup rates are adequate, e.g. more than 30%. If affirmative, process 400 continues to a step 450 of checking the first 48 hours milestone. Alternatively, step 440 proceeds to a step 445 of generating a signup action list. The signup action list is focused on creating a value added hands on engagements to increase sign-up rates. The signup action list may include the follows considerations:
Is the pricing strategy clear? Complicated pricing models create resistance
Can the advertised product or service be tried with little risk?
Does the website justify why someone should choose you?
Does the website make it easy for someone to distinguish the entity from other players in the field?
Can the advertised product be “played with” first, before asking for a sign on? Suggested configuration to reconfigure the website and/or product to enable trial.
Is the sign on asking for too much information? Asking for too much up-front creates resistance. Suggested configuration—“simplify sign-up”.
Can the advertised product or service be purchased easily online? Suggested configuration to reconfigure the website to enable online shopping.
Can a visitor create an account and start playing with a basic (even non-customisable) version of the advertised product? Suggested configuration to reconfigure the website and/or product to enable trial.

The signup action list may also include a recommendation to engage a digital agency for help with marketing strategy, graphic design, UX design and web design.

Step 450 checks the first 48 hours milestone, i.e. “Do you make my life better” milestone. Step 450 may determine whether the website signup retention and engagement rates are adequate, e.g. more than 30%. If affirmative, process 400 continues to a step 460 of checking the upgrade milestone. Otherwise, step 450 proceeds to a step 455 of generating a first 48 hours action list.

The first 48 hours action list may broadly recommend creating a smooth onboarding experience to increase post-signup rates. The first 48 hours action list may include the following considerations:
Are your the sign-on churn (or abandon) rates high (70% +)?
Is it possible to succeed in the first 48 hrs after signing on, regardless of how complicated the full-featured product is?
Is it clear what to do after sign-on?
Is it easy to get done what visitors need to do?
Can visitors figure out how to make the advertised product work for them?

The first 48 hours action list may also recommend engaging a digital Agency for UX design, web design and usability testing. Step 455 continues to step 480.

Step 460 determines whether the upgrade milestone is met. For example, step 460 may determine whether the upgrade rates (i.e. conversion to premium products) are adequate, i.e. above 30%. If affirmative, process 400 continues to a step 470 of checking the loyalty milestone. Otherwise, step 460 proceeds to a step 465 of determining an upgrade action list.

The upgrade action list targets refining product user experience (UX) and value proposition to increase conversion rates. The upgrade action list may include the following considerations:
Usability tests on the advertised product to determine whether the customers are able to use the advertised product successfully.
Understanding why customers do not upgrade. Consider if free version of the advertised product may be doing the job too well.
Testing the value proposition to determine if the value proposition matches reasons the visitors buying the products advertised on the website.
Consider conducting periodic interviews with high value customers to make sure that the customers continue to perceive value in your offering.

The upgrade action list may also recommend engaging a digital agency for UX design and usability testing. Step 465 continues to step 480.

Step 470 determines whether the loyalty milestone is met. For example, step 470 may determine whether the repeat buy rates are adequate, i.e. above 30%. If affirmative, process 400 continues to a step 488 of repeating process 400 after each website update. In alternative implementations, rather than proceeding to step 488 the process may conclude. Otherwise, step 470 proceeds to step 480 of determining a loyalty action list.

The loyalty action list may focus on a marketing strategy to communicate repeat buy (“re-buy” or “rebuy”) value to consequently increase repeat buy rates. The loyalty action list may include the following considerations:
Reconfiguring the website to periodically remind the customers of the value of the entity.
Reconfiguring the website to remind customers to continue to use your products/subscribe to your offerings.
Reconfigure the website to implement sharing functionality to make it easy for the customers to share their experience of using your offering with people who are like them.
Reconfigure the website to implement rewarding program to reward customers for referrals.
Reconfigure the website to make your existing customers feel special when they repeat buy.
Reconfigure the website to implement a simplified repeat buy functionality to make rebuys easy.

The loyalty action list may also recommend engaging a digital agency with access to skills in customer success, marketing strategy and UX design. Step 475 proceeds to step 480 of updating the website based on the determined configurations.

The configurations may be determined using the interactive digital representation together with the proposed configuration. For example, the configuration related to the keywords may be determined by deriving suitable keywords from the HTML code of the website. In step 480, portions of the HTML code of the website may be modified based on the instructions provided in the configuration.

Process 400 continues from step 480 to a step 482 of determining an updated brand loyalty score. The updated brand loyalty score is compared with the previous brand loyalty score or the first brand loyalty score at step 484. If the updated brand loyalty score has not improved, the process 400 proceeds to a step 486 of returning to the current action list and selecting a different configuration and/or suggestion and recursively updating the website at step 480. Otherwise, the process 400 proceeds to step 488 of repeating the process after each website update. Alternatively, the process 400 may conclude.

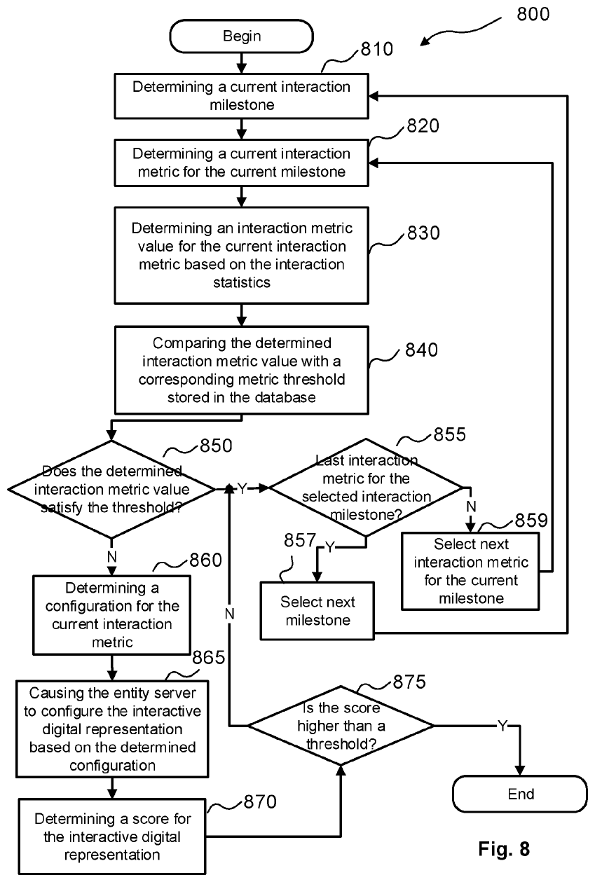

FIG. 8 is a flow-chart demonstrating a method 800 of configuring an interactive digital representation in accordance with another implementation of the present disclosure. Method 800 is implemented on the processor 305 executing instructions stored in memory 309. In some implementations, method 800 is implemented as a web service, i.e. the method 800 is executed on a web server in response to receiving a command, via the Internet, from a web browser.

Method 800 starts at a step 810 of determining a current interaction milestone. The current interaction milestone may be stored as a variable in memory 306 or 333 associated with the processor 305. In some implementations, method 800 may commence with the first interaction milestone. Step 810 proceeds to a step 820 of determining a current interaction metric for the current milestone. The current interaction metric for the current milestone may be stored as a variable in memory 306 or 333.

Method 800 continues from step 820 to a step 830 of determining an interaction metric value for the current interaction metric based on the interaction statistics associated with the current interactive digital representation. For example, the interaction statistics may provide a plurality of numerical values representing user's interaction with the current interactive digital representation. The method 800 may select one or more numerical values corresponding to the relevant interaction metric. The selected numerical value(s) may be assigned to the current interaction metric and referred to as an interaction metric value.

Step 830 proceeds to a step 840 of comparing the determined interaction metric value with a corresponding metric threshold stored in the database. In some implementations, the database may be stored in memory 309 of the computer system 300. If the processor determines at step 850 that the interaction metric value satisfies the threshold, method 800 proceeds to a step 855 of determining whether the current interaction metric is the last interaction metric for the current interaction milestone. Step 855 may be implemented by searching the database for interaction metric(s) assigned to the current interaction milestone.

If affirmative, method 800 proceeds to a step 857 of selecting a next milestone in the database and updating the current milestone variable to the selected next milestone. Step 857 proceeds to step 810. If the current interaction metric is not the last interaction metric for the current milestone, the method 800 proceeds to a step 859. The processor at step 859 selects a next interaction metric for the current milestone from the database and updates the current interaction metric variable to the selected interaction metric variable. Method 800 proceeds to step 820 discussed above.

Returning to step 850, if the processor 305 determines that the determined interaction metric value does not satisfy the threshold, method 800 continues to a step 860 of determining a configuration for the current interaction metric. In some implementations, the method 800 may store all metrics which do not satisfy corresponding thresholds in an array and determine relevant configurations for all metrics collectively.

The configuration may be determined using a configuration associated with the current interaction metric stored in the database and features identified in the interactive digital representation. For example, step 860 may extract features from an HTML code of the interactive digital representation. The features may include keywords appearing in the interactive digital representation, arrangement of text, fonts, images, combination of colours etc. Step 860 may identify features corresponding to the configuration associated with the current interactive metric. For example, extracted keywords may be assigned to the keyword configuration while features related to fonts and arrangement of text may be assigned to aesthetics configuration. Once features are assigned to configurations, the features may be refined based on instructions stored in the configuration. For example, more popular keywords synonymous to the extracted keywords may be used or more appealing fonts and/or arrangement of text may be used. The final configuration is determined using the refined features, for example, as a substitute portion of the HTML-code. In some implementations, the configuration stored in the database can be used effectively as a template where the refined features can be inserted.

Step 860 proceeds to a step 865 of causing the entity server to configure the interactive digital representation based on the determined configuration. For example, the processor may send the final configuration to the entity server to update the HTML code.

In some implementations, step 865 stores a plurality of determined configurations for one or more interaction metric which does not satisfy corresponding metric thresholds. Each of the determined configurations is applied based on a corresponding milestone the configuration is intended to fix. For example, a priority of milestones may be stored in memory of the application program 333 and the configurations may be applied in accordance with the stored priorities of the milestones with which the configuration is associated. The priorities are intended to improve return on investment.

For example, a brand X requested execution of method 800. Method 800 indicates that the brand X is below a threshold on the ten seconds milestone and also below a threshold on the first 48 hour milestone. In other words, not enough traffic is coming to the website and out of visitors that do sign up 90% churn within the first two days after sign up. In this case, since priority of the first 48 hour milestone is higher, the method 800 at step 865 may prioritise one or more configuration associated with the first 48 hour milestone first. Once the configuration(s) associated with the first 48 hour milestone are applied, the step 865 may proceed to applying configurations associated with the 10 seconds milestone. Accordingly, once the website does get more, less of that traffic would churn shortly after sign-up. The intention behind prioritization is to address traffic leaks first and then increase advertising spend to drive more traffic. As such, prioritization would ultimately result in retaining more visitors overall.

In one implementation, priorities of milestones and therefore associated configurations may be as follows:
1. The first 48 hours milestone;
2. The sign-up milestone, i.e. configurations adapted to address sign-up difficulties to improve the ratio of website visitors to sign-ups each month;
3. The ten seconds milestone, i.e. improve your value proposition to increase likelihood of engaging website visitors early;
4. The three minutes milestone, i.e. outline the brand story in the right way;
5. The zero seconds milestone; and
6. The upgrade and loyalty milestones.

Method 800 continues to a step 870 of determining a DBR score for the interactive digital representation. The DBR score may be determined by combining scores for each milestone weighted based on corresponding milestone weighting coefficients.

Step 870 proceeds to a step 875 of determining whether the score is higher than a threshold. The threshold can be stored in memory of the server 620 or be determined as a previous DBR score of the interactive digital representation. If the score is higher, method 800 concludes. Otherwise, method 800 proceeds to step 855.

The disclosed arrangements provide a milestone-based process for optimising brand buyer relationships. Additionally or alternatively, the discussed metrics may be used to indicate which of the milestones in the relationship may be underperforming.

Additionally, a machine learning (AI) system may be used to determine relative contribution of each milestone to the relationship, e.g. weighting coefficients for the milestones. Accordingly, the AI system may work in combination with milestones and metrics attributed to each milestone to identify issues in the digital brand buyer relationship. For example, the AI system may extract features from the usage statistics and/or the website and map the extracted feature to a corresponding metric to identify issues in the digital brand buyer relationship, explain causes of the identified issues, suggest possible fixes, monitor whether the changes deployed (e.g. to the website) improved the relationship or not, and learn/adjust the weighting coefficients and thresholds each time the system is used.

FIG. 2 shows dataflow diagram 200 of an AI system in accordance with one implementation of the present disclosure. The AI system uses a digital brand footprint 220 as an input. The digital brand footprint 220 may be used to determine website traffic and usage data 230. The website traffic and usage data 230 is sent to an ADORE process 250 configured using an ADORE AI learning system 240. The AI learning system 240 stores and refines emotional milestones 241, default threshold for milestones 243 and weighting coefficients (impacts) on conversion rate for milestones with each iteration. The AI learning system 230 provides data to the ADORE process 250.

The ADORE process uses the emotional milestones 251, weighting coefficients 252 which identify strength of each milestone, default thresholds 253 for each milestone, brand specific thresholds 254 for each milestone, causes of issues for each milestone 255, remedies for issues 256, remedy—capability matrix 257 to determine the brand romance score 258 and generate the action plan 259 to improve the brand romance score as discussed above. The digital brand romance score 258 may be output as a score 270 to the user. The Action plan 259 may be converted into a set of instructions 260 to update code 225. Additionally, the action plan 259 may be fed back to the AI learning system 240 so that the AI learning system may refine or adjust weighting coefficients 245, thresholds 243 and/or metrics/features for milestones 241.

The AI tool/system as above, may connect marketing and design decisions to impact on conversion rates and sales. For example, each time the system is used to identify an issue (at one of the milestones), and a fix is deployed, the AI system may collect additional information over time to allow the AI system to learn which impacts a proposed adjustment is likely to make, e.g. “fixing the value proposition is likely to reduce your bounce rates by 300% and increase your sales conversion rates by 51.4%”.

The disclosed arrangements provide a systematic, repeatable and vetted process for advantageously increasing conversion rates from 3% industry average rates to more than 40%. Additionally, the disclosed arrangements facilitate and improve efficiency of designing new interactive digital representations and optimise marketing effort. The advantages are founded on the premise that strong relationships between buyer and brand equate to more sign-ups, and consequently, more sales and stronger brand advocacy.

Additionally, the DBR score of the present disclosure may be used as a tool to measure performance of work done by digital agencies to allow an e-commerce business owner to better understand which services they need to engage.

For example, a business owner may subconsciously know that they need to hire a marketing or web agency, but do not know which one to pick. Existing systems do not provide mechanisms for objectively determining which capabilities are required and/or strengths of different agencies. As such, business owners tend to pick someone that “looks good” to do work with hope that the work improves profitability. However, such an approach is largely a guesswork since there is no way to objectively assess needs of the business and performance of the agencies.

With the DBR score as discussed above, the impact of changes made to the digital footprint may be objectively measured, i.e. changes in the DBR score may be attributed to how good the agency is doing the work. As such, the DBR score may also be used to measure performance of agencies. For example, if a business owner would like to pick an agency, the present disclosure allows the business owner to base their decision on objective performance measurements, such as an impact the agency makes to the DBR score or a score for each individual milestones. By knowing that Agency A typically delivers improvements of 20% in milestone Y and Agency B delivers improvements of 35% for the same milestone as determined based on changes in the associated DBR scores, the business owner can pick Agency B.

It should be understood by those skilled in the art that various modifications, combinations, sub-combinations and alterations may occur depending on design requirements and other factors insofar as they are within the scope of the appended claims or the equivalents thereof.

Reference to background art or other prior art in this specification is not an admission that such background art or other prior art is common general knowledge in Australia or elsewhere.

### INDUSTRIAL APPLICABILITY

The arrangements described are applicable to the computer and data processing industries and particularly for the configuring an interactive digital representation of an entity.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A system for configuring an interactive digital representation of an entity, the system comprising:
a processor;
a database coupled with the processor, the database being configured to store a plurality of interaction milestones in association with at least one interaction metric and a corresponding metric threshold, each interaction metric being associated with a configuration corresponding to the interaction metric; and
memory coupled with the processor, memory being configured to store instructions which, when executed by the processor, cause the processor to:
a) receive a current interactive digital representation of an entity and interaction statistics for the current interactive digital representation;
b) for at least one interaction milestone, determine an interaction metric value for an interaction metric associated with said interaction milestone based the interaction statistics;
c) determine at least one candidate interaction metric of the interactive digital representation for reconfiguring by comparing each of the determined interaction metric values with a corresponding metric threshold stored in the database;
d) determine a configuration for the interactive digital representation using the configuration stored in the database for the at least one candidate interaction metric and the current interactive digital representation; and
e) cause the entity server to configure the interactive digital representation based on the determined configuration to thereby update the current interactive digital representation of the entity.

2. The system according to claim 1, wherein the processor is further configured to adjust the metric thresholds based on the entity.

3. The system according to claim 1 or claim 2, wherein the interaction milestones relate to duration of interaction of a user with the current interactive digital representation of the entity.

4. The system according to claim any one of the preceding claims, wherein the plurality of interaction milestones comprises a zero second interaction milestone, a ten seconds interaction milestone, a three minutes interaction milestone, a sign-up milestone, a first forty eight hours after sign-up milestone, and an upgrade milestone.

5. The system according to any one of the preceding claims, wherein the database is further configured to store a weighting coefficient for each interaction milestone.

6. The system according to claim 5, wherein memory is further configured to store instructions which, when executed by the processor, cause the processor to:
determine an entity score by combining interaction metric values for the plurality of interaction milestones weighted based on a weighting coefficient associated with a corresponding interaction milestone; and
cause a display screen to display, on a user interface, the determined entity score to a user.

7. The system according to claim 6, wherein memory is further configured to store instructions which, when executed by the processor, cause the processor to:
in response to receiving, via the user interface, an indication from the user to improve the entity score, generate a configuration report using the determined entity score and the determined configuration and cause the display screen to display the generated report on the user interface.

8. The system according to any one of the preceding claims, wherein memory is further configured to store instructions which, when executed by the processor, cause the processor to repeat steps a) to e) if the determined entity score is below an entity score threshold.

9. The system according to any one of the preceding claims, wherein step e) comprises prioritising the determined configuration based on a priority of the configuration stored in the database.

10. A method of configuring an interactive digital representation of an entity, the method comprising:
a) receiving a current interactive digital representation of an entity and interaction statistics for the current interactive digital representation;
b) for at least one interaction milestone, determining an interaction metric value for an interaction metric associated with said interaction milestone based the interaction statistics;
c) determining at least one candidate interaction metric of the interactive digital representation for reconfiguring by comparing each of the determined interaction metric values with a corresponding metric threshold stored in a database, wherein the database stores a plurality of interaction milestones in association with at least one interaction metric and a corresponding metric threshold, each interaction metric being associated with a configuration corresponding to the interaction metric;
d) determining a configuration for the interactive digital representation using the configuration stored in the database for the at least one candidate interaction metric and the current interactive digital representation; and
e) causing the entity server to configure the interactive digital representation based on the determined configuration to thereby update the current interactive digital representation of the entity.

11. The method according to claim 10, further comprising adjusting the metric thresholds based on the entity.

12. The method according to claim 10 or claim 11, wherein the interaction milestones relate to duration of interaction of a user with the current interactive digital representation of the entity.

13. The method according to any one of claims 10 to 12, wherein the plurality of interaction milestones comprises a zero second interaction milestone, a ten seconds interaction milestone, a three minutes interaction milestone, a sign-up milestone, a first forty eight hours after sign-up milestone, and an upgrade milestone.

14. The method according to any one of claims 10 to 13, wherein the database stores a weighting coefficient for each interaction milestone.

15. The method according to claim 14, further comprising:
determining an entity score by combining interaction metric values for the plurality of interaction milestones weighted based on a weighting coefficient associated with a corresponding interaction milestone; and
causing a display screen to display, on a user interface, the determined entity score to a user; and
in response to receiving, via the user interface, an indication from the user to improve the entity score, generating a configuration report using the determined entity score and the determined configuration and causing the display screen to display the generated report on the user interface.

16. The method according to any one of claims 10 to 15, further comprising repeating steps a) to e) if the determined entity score is below an entity score threshold.

17. The method according to any one of claims 10 to 16, wherein step e) further comprises prioritising the determined configuration based on a priority of the configuration stored in the database.

18. An apparatus for configuring an interactive digital representation of an entity, the apparatus comprising a processor configured to perform the method of any one of claims 10 to 17.

19. A non-transitory computer-readable storage medium for configuring an interactive digital representation of an entity, the computer-readable storage medium storing instructions which, when executed by a processor, cause the processor to perform the method of any one of claims 10 to 17.
